(19) United States
(12) Patent Application Publication
(10) Pub. No.: US 2007/0295692 A1
(43) Pub. Date: Dec. 27, 2007

(54) Fault tolerant high voltage switching elements and electrical components

(76) Inventors: Frank John Muench, Waukesha, WI (US); Jerry Lee Corkan, Waukesha, WI (US)

Correspondence Address: KING & SPALDING LLP, 1180 PEACHTREE STREET, ATLANTA, GA, 30309-3521, US

(21) Appl. No.: 11/473,416

(22) Filed: Jun. 22, 2006

(51) Int. Cl. H01H 33/04

(52) U.S. Cl. 218/83

(57) ABSTRACT

Liquid-filled high voltage switching units and electrical components including a primary tank and a secondary tank that do not communicate with one another in normal operation.

### BACKGROUND OF THE INVENTION

This invention relates generally to electrical power distribution systems, and more specifically to high voltage electrical components with integrated switching capability.

Electrical power is typically transmitted from substations through cables, which interconnect other cables and electrical apparatus in a power distribution network. Electrical components such as power distribution capacitors and transformers are interconnected in the network via high voltage cables, and a variety of switchgear is used to connect and disconnect power connections to the components and associated circuitry. Improvements in the high voltage switchgear and switching elements for power distributions systems are desirable.

### BRIEF DESCRIPTION OF THE DRAWINGS

FIG. 1 is a perspective view of a high voltage, fault tolerant electrical component.

FIG. 2 is a cross sectional schematic view of the component shown in FIG. 1.

FIG. 3 is a front view of another embodiment of a high voltage electric component.

FIG. 4 is a side schematic illustration of the component shown in FIG. 3.

FIG. 5 is a top schematic illustration of the component shown in FIGS. 3 and 4.

FIG. 6 illustrates another embodiment of an electrical component in accordance with the invention.

FIG. 7 illustrates a cross section schematic view of the component shown in FIG. 6 taken along the line 7-7.

FIG. 8 illustrates yet another embodiment of an electrical component in accordance with the invention.

FIG. 9 illustrates a method flowchart of a method of assembling the components shown in FIGS. 1-8.

### DETAILED DESCRIPTION OF THE INVENTION

Improvements in switching elements and switchgear for high voltage applications, such as applications carrying more than 1000 volts in a power distribution network, are provided in exemplary embodiments of the present invention. Switching elements and switchgear are provided that capably meet demanding requirements and safety standards while avoiding disadvantages, described below, of known switching devices and switchgear. In order to appreciate the benefits of the invention to its full extent, the disclosure herein will be segmented into different parts. Part I discusses known switching elements and problems associated therewith. Part II discusses exemplary embodiments of switching devices, switchgear, components and systems according to the present invention. Part III discusses methods associated with the exemplary embodiments of Part II.

I. Introduction

High voltage switchgear is known that includes switching elements immersed in a dielectric fluid, such as mineral oil, less flammable fluids such as FR3™ fluid or RTEMP fluid, silicone fluids, and synthetic esters and other liquids, contained within a tank. As used herein, the term “liquid” shall refer to the above-identified liquids and other liquids providing dielectric withstand capability, cooling and arc interruption properties. While such switchgear utilizing dielectric fluids can be effective in a power distribution network, they are prone to certain problems. For example, if an arc occurs inside of a fluid filled tank, a very high-pressure transient may occur that can cause tank seams, welds or gaskets to break or rupture and present hazardous conditions including fire at locations external to the tank. High current arcs within the headspace of the tank near the top of the liquid or over the top of the liquid may result in additional pressure being created in the headspace that can cause disruption of the tank. Emerging standards promulgated by the International Electrotechnical Commission (IEC) require switchgear to withstand a current of 16 kA or more for a duration of 0.5 to 1.0 second in the event that the switchgear fails. Known liquid-filled switchgear has been found to be generally incapable of meeting such requirements because of the tendency of the tanks to rupture under the specified conditions.

Some known high voltage electrical components may employ integral switching elements in operation. For example, power distribution transformers are known that include core and coil assemblies that are immersed in a dielectric liquid within a tank, and switching elements for the core and coil assemblies are also immersed in the dielectric liquid within the tank. The switches are therefore operated in the same insulating liquid as the transformer and in a common tank. When the switches break load current, carbonaceous by-products may be created, which potentially could reduce the dielectric withstand capability of the transformer.

Additionally such transformers typically have a headspace of two to six cubic feet of air over the liquid surrounding the core-coil. Should the switches in the tank fail for any reason, the resulting arc within the insulating liquid surrounding the switches can generate large amounts of gas. This may result in the rupture of the tank causing flame outside the tank, increasing the risk to the public. When the fluid in the tank is subjected to a current of 16 kA or more for a duration of 0.5 to 1.0, the tanks of such transformers have been known to rupture.

High voltage switching devices are known that are contained in a housing and insulated with sulfur hexafluoride (SF₆). In Europe such switching devices are sometimes referred to as a ring main switch, and are used in combination with power distribution transformers. The ring main switch is separately housed from the transformer but is connected to the transformer to provide switching, grounding and operational capability to distribution transformers. For security purposes, to avoid tampering with the transformer and switch, the transformer and switch are typically provided in a special kiosk or in a separate room within a building. Having separate switches and transformer devices increases the amount of space, sometimes referred to as a footprint, occupied by the devices.

Switching elements insulated with SF₆ gas may capably meet applicable regulations and performance requirements, including withstanding fault or failure currents of 16 kA or more for a duration of 0.5 to 1.0 second without damage to the switch. The insulative properties of SF₆ are well known and SF₆ is effective as an arc-interrupting medium. Additionally, SF₆ gas provides a degree of safety as it is non-flammable. Undesirably, however, SF₆ gas insulation is a potent greenhouse gas. If the tank ruptures or burns through during electrical arcing conditions, which has been experienced in use, toxic and corrosive by-products of the arcing can be released into the ambient environment. In particular, in the presence of water, these byproducts can result in the formation of strong acids that can cause health issues or damage to other devices in proximity to the switches. In light of environmental concerns regarding SF₆ gas it would be desirable to provide a more environmentally friendly alternative for use in switching devices.

II. Inventive Switching Units and Components

The present invention overcomes these and other difficulties by providing liquid insulated high voltage switching units and equipment that may capably withstand a current of 16 kA or more for a duration of 0.5 to 1.0 second or longer without rupturing and creating hazardous conditions in the vicinity of the switching units and equipment. SF₆ gas insulation may be avoided, and electrical components such as transformers may be provided with integral switching capability in a smaller footprint than separately housed switches and transformers. As explained in detail below, this is achieved by providing switching elements in separate, conjoined tanks where the switching is to occur. Performance requirements may therefore be met in a safe and environmentally friendly manner without external rupture of the tank structure to release the contents of the tank structure to the external environment. The invention will be explained in relation to the following Figures, but it shall be understood that the drawings are schematic in nature and are not to scale. Of course, actual dimensions will vary according to the internal components utilized therein and for different kVA ratings desired.

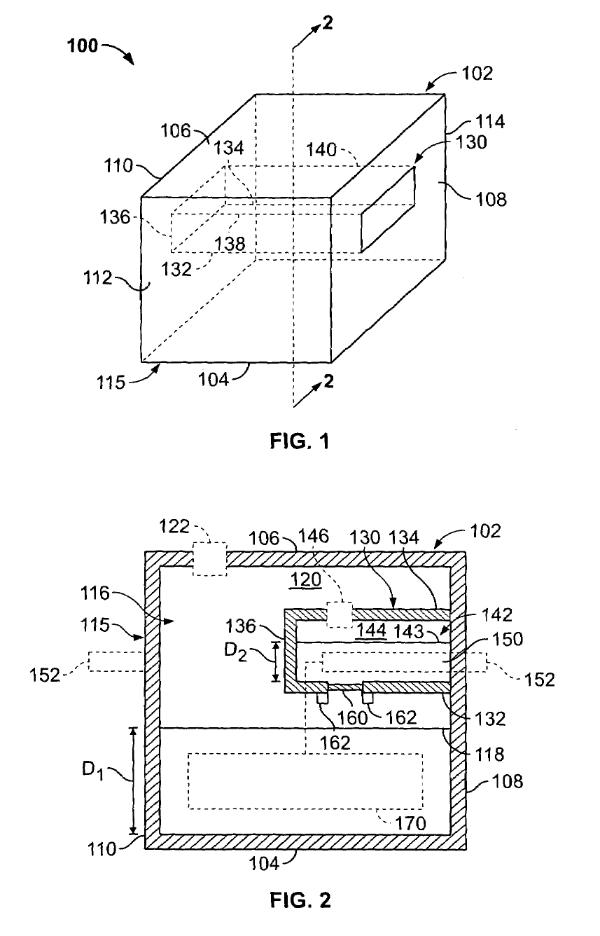

FIG. 1 illustrates an exemplary embodiment of a high voltage electric component 100 that may be used as a stand-alone high voltage switchgear device, or alternatively may be adapted for use as a high voltage electric component, such as a power distribution transformer, with integrated switching capability. As shown in FIGS. 1 and 2, the component 100 includes a body 102 that may be assembled from metal plates that are joined to one another to collectively define a tank structure for a liquid-insulated switching element and if desired, other components such as transformer switches, a coil and core assembly, and protective components, such as fuses, primary breakers, and current limiters. In an exemplary embodiment, the body 102 may be fabricated from metal plates having a thickness of about 5 mm and preferably at least 6 mm thick, although the body 102 may be alternatively fabricated from other materials of various thickness and formed into the body 102 by various methods known in the art.

In an exemplary embodiment, the body 102 may include a bottom wall 104, a cover or top wall 106 opposing the bottom wall 104, a front wall 108 interconnecting the bottom and top walls 104 and 106, a back or rear wall 110 opposite the front wall 108 and interconnecting the bottom and top walls 104 and 106, and opposing side walls 112 and 114 joined to respective end edges of the bottom wall 104, the top wall 106, the front wall 108, and the back wall 110. The walls 104-114 may be assembled and welded, riveted, or otherwise joined together in any known manner. When assembled, the walls 104-114 of the body 102 form an outer enclosure, sometimes referred to herein as a main or primary tank 115. The main tank 115 defines a generally hollow and generally rectangular interior cavity or volume 116 (FIG. 2) extending therebetween. Welded seams, sealing gaskets and the like may be provided to seal the primary or main tank 115. While illustrated as a generally orthogonal and rectangular tank 115, the main tank may be fabricated into alternative shapes, such as oval or round, if desired.

As shown in the FIG. 2, the interior volume 116 of the main tank 115 may be filled to a first depth D₁, measured from the inner surface of the bottom wall 104, with a liquid dielectric fluid 118. The depth of fluid 118 in the main tank 115 only partially fills the main tank 115. The dielectric fluid 118 may be a liquid dielectric fluid including, for example, base ingredients such as mineral oils or vegetable oils, synthetic fluids such as polyolesters, silicone fluids, mixtures of the same, or other insulative fluids known in the art. One liquid dielectric fluid that is suitable and advantageous as the dielectric fluid 118 is formulated from edible seed soil and food grade performance additives and has a high fire point, one example being ENVIROTEMP® FR3™ fluid available from Cooper Power Systems of Waukesha, Wis., although this particular fluid is by no means required. Preferably, the main tank 115 does not include SF₆ gas insulation, although it is understood that gaseous insulation materials such as SF₆ could be used if desired.

Optionally, a portion 120 that is not occupied by the dielectric fluid 118 in the main tank 115, sometimes referred to as headspace of the main tank 115 may be filled with nitrogen, another other gas, or combination of gases that will not burn when combined with gaseous by-products produced during arcing. In such a manner, an inert gas blanket may be provided in the main tank 115. The inert gas blanket overlies the dielectric fluid 118 in the headspace 120, and a pressure relief device 122 (shown in phantom in FIG. 2) may be provided in one of the walls 104-114 defining the main tank 115 to regulate pressure in the main tank 115. As one example, the pressure relief device 122 may be a known spring-loaded valve that is forced open by specified pressure conditions. As such, pressure conditions within the main tank 115 that exceed a certain threshold level, dependent upon the configuration and characteristics of the pressure relief device 122, may cause the pressure relief device 122 to open and relieve pressure from the interior of the main tank 115 to the ambient environment external to the body 102. As the pressure within the main tank 115 returns to the threshold level, the pressure relief device 122 returns to a closed state.

As is also illustrated in FIGS. 1 and 2, the body 102 also defines a secondary tank 130 integral to the main or primary tank 115. The secondary tank is sometimes referred to herein as a switch tank, and is located generally interior to and is conjoined with the main tank 115 in the body 102. In an exemplary embodiment, the switch tank 130 shares the front wall 108 of the main tank 115, and the switch tank includes a bottom wall 132, a top wall 134, a rear wall 136 and opposing side walls 138 and 140 collectively forming a second hollow space or interior volume 142 therebetween. The walls 132-140 of the switch tank 130 are spaced from the walls 104, 106, 110, 112 and 114 of the main tank 115. Thus, in an exemplary embodiment, while the front wall 108 is common to each of the main tank 115 and the switch tank 130, a double wall construction is otherwise provided in the body 102 to define the main tank 115 and the switch tank 130. While a common front wall 108 shared by each of the main tank 115 and the switch tank 130 is preferred, it is certainly not required to achieve at least some of the benefits of the present invention.

In an exemplary embodiment, the bottom wall 132 of the switch tank 130 is positioned above the fluid level or the depth D₁ of fluid in the main tank 115 so that the entire switch tank 130 is positioned in the headspace 120 of the main tank 115. Thus, when a nitrogen blanket is provided in the headspace 120 of the main tank 115, the nitrogen blanket surrounds and insulates the switch tank 130. While the switch tank 130 is located in the headspace 120 of the main tank 115, the interior volume 142 of the switch tank 130 is distinct from the interior volume 116 of the main tank 115. That is, the interior volumes of the main tank 115 and the switch tank 130 are not in fluid communication with one another during normal use. Welding seams, sealing gaskets, and the like may be provided in the switch tank 130 to isolate the interior of the switch tank 130 from the main tank 115. While the switch tank 130 functions as a separate tank from the main tank 115, the switch tank 130 is generally surrounded by the interior volume 116 of the main tank 115, and the switch tank 130 is smaller in dimension than the main tank 115.

As shown in the FIG. 2, the switch tank 130 may be filled to a depth D₂, measured from the inner surface of the bottom wall 132 of the switch tank 130, with a dielectric fluid 143. The dielectric fluid 143 may be a liquid dielectric fluid including, for example, base ingredients such as mineral oils or vegetable oils, synthetic fluids such as polyolesters, silicone fluids, mixtures of the same, or other insulative liquid fluids known in the art. One liquid dielectric fluid that is suitable and advantageous as the dielectric fluid 118 is formulated from edible seed soil and food grade performance additives and has a high fire point, one example being ENVIROTEMP® FR3™ fluid available from Cooper Power Systems of Waukesha, Wis., although this particular fluid is by no means required. Preferably the switch tank does not include SF₆ gas insulation, although gaseous insulation, including SF₆ gas may be used if desired. Because the switch tank 130 is smaller than the main tank 115, the amount of dielectric fluid 143 in the switch tank 130 is less than the amount of dielectric fluid 118 in the main tank 115. The dielectric fluids 118 and 143 in the main tank 115 and the switch tank 130 may be the same or different from one another.

Optionally, the remaining interior volume 144, sometimes referred to as the headspace, of the switch tank 130 that is not occupied by the dielectric fluid 143 may be filled with nitrogen, another gas, or combination of gases that will not react with the gases generated during arcing. An inert gas blanket overlying the dielectric fluid 143 in the switch tank 130 is therefore provided. A pressure relief device 146 may be provided in one of the walls defining the switch tank 130 to limit excessive operating pressures in the switch tank 130 during routine operation. The pressure relief device 146 in the switch tank 130 may be the same or different from the pressure relief device 122 in the main tank 115. In an alternative embodiment, a pressure regulating device may be provided to limit excessive positive and negative pressures within the switch tank 130.

By virtue of the pressure relief device 146 in the switch tank 130, pressure conditions within the switch tank 130 that exceed a certain threshold level, dependent upon the configuration and characteristics of the pressure relief device 146, may cause the pressure relief device 146 to open and relieve pressure from the smaller switch tank 130 into the larger main tank 115. As the pressure within the switch tank 130 returns to the threshold level, the pressure relief device 146 returns to a closed state. The threshold levels for the operation of the pressure relief devices 122 and 146 provided in the main and switch tanks 115 and 130 may be the same or different from one another in different embodiments of the invention.

As shown in FIG. 2, a switching element, mechanism or component 150 (collectively referred to herein as a switching device) may be contained and confined in the switch tank 130. The switching device 150 may be immersed in the dielectric fluid 143 in the switch tank 130, and known electrical connectors such as bushings 152 may be used to establish line and load connections to the switching device 150. Any known switching element, mechanism or component may be used for the switching device, including but not limited to sectionalizing switches and loadbreak switches for single phase and polyphase high voltage systems. Such switching devices 150 and associated electrical contacts and actuation mechanisms are well known and are not described in detail herein.

Connector bushings 152 and the like for establishing line and load connections are also well known and are not described in detail herein. Busbars, cables and the like may be used as appropriate to connect the switch device 150 to the bushings 152 or connectors within the switch tank 130 and/or the main tank 115. The switching device 150 may also be used in combination with protective elements such as current limiting fuses and other current limiting devices as desired, and protective elements and devices may be included in either or both of the switch tank 130 and the main tank 115.

Providing the smaller switch tank 130 within the larger main tank 115 tends to shorten electrical arcs occurring in the switch tank 130 where switching of the high voltage connection actually occurs. Shortening of electrical arcs in the switch tank 130, as opposed to longer arcs occurring in the larger main tank 115 reduces arc resistance. In turn, reducing arc resistance to a lower level in the smaller switch tank 130 results in less arc power, and less internal pressure results from the current flowing through switch tank 130. Because the interior of the switch tank 130 is separate and distinct from the interior of the main tank 115, arcing by-products resulting from load current switching in the switch tank 130 are confined to the switch tank 130 and do not otherwise degrade dielectric characteristics of the fluid 118 in the main tank where, for example, protective devices or other electrical components may be contained. In addition the switch tank 130, being composed of metal plates, will cool the area immediately around an arc occurring in the switch tank 130, again reducing tank pressure in the switch tank 130 and the possibility of rupture of the switch tank 130.

Because the switch tank 130 is surrounded by the main tank 115, even if the switch tank 130 does rupture, contents of the switch tank 130 are contained within the larger main tank 115 instead of entering the external environment in the vicinity of the component 100. Because the main tank 115 is larger than the switch tank 130, excessive pressure in the switch tank 130 will be substantially reduced when introduced into the larger main tank 115, while preventing the contents of the ruptured switch tank 130 from reaching the external environment.

In an exemplary embodiment, and as an added measure of safety and protection, the switch tank 130 may be provided with one or more bursting plates or bursting features. That is, one or more of the plates or materials defining or securing the walls of the switch tank 130 may be fabricated to break, rupture or burst when specified pressure conditions occur within the switch tank 130. For example, and as illustrated in FIG. 2, a section 160 of the bottom wall 132 of the switch tank 130 may be fabricated from thinner metal than the remaining walls of the switch tank 130. Because of the thinner material in the section 160 of the bottom wall 132, the bottom wall 132 has a reduced structural strength than the remaining walls of the switch tank 130. With strategic selection of the material in the section 160 and its thickness, the section 160 may be designed to give way or fail when certain pressure conditions occur inside the switch tank 130, causing the contents of the switch tank 130 to spill into the main tank 115. Thus, for example, the bursting section 160 of the switch tank 130 may be selected to burst when a fault current of 16 kA is experienced for a duration of 0.5 seconds or longer in the switch tank 130. The pressure corresponding to such a condition may be empirically determined for a given size of switch tank 130, and the bursting section 160 may be appropriately selected for the empirically determined pressure. If one or more pressure relief devices 146 are provided in the switch tank 130, the pressure relief devices may work in combination with the bursting section 160 to extend an arc duration time that is sufficient to create enough pressure to burst the switch tank 130.

In a further and/or alternative embodiment, the thin walled section 160 of the bottom wall 132 may be attached to the switch tank 130 with fasteners 162 such as screws, nuts and bolts, that are designed to shear when pressure in the switch tank 130 produces a load on the fasteners 162 in a specified amount, thereby causing the fasteners 162 to give way to release the contents of the switch tank 130 into the main tank 115.

If desired, more than one switch tank 130 may be provided in the larger main tank 115 to define separate compartments in separate switch tanks each containing respective under-oil or liquid switching devices therein. Bursting features and pressure relief devices may be provided in each of the switch tanks as described above. Providing multiple switch tanks 130 may be desirable to simplify bursting features for smaller tanks and for more predictable and reliable operation of the bursting features. It should be noted, however, that a single switch tank 130 of a larger size holding more than one switching device 150 may be preferable to utilizing multiple switching tanks of a smaller size because the larger amount of fluid in a larger switch tank can be advantageous should any of the switching devices fail or should fault currents be experienced. More specifically, a larger amount of fluid in a larger switch tank may allow for greater dispersion of any arcing by-products resulting from load current switching created in the switching tank. A larger amount of headspace in a larger switching tank may also be beneficial in reducing pressure buildup in the switch tank during arcing conditions. Utilizing more than one switch tank may also require additional welding and additional bushings, resulting in higher costs.

While thus far the invention has been described in the context of a stand-alone switching unit 100, the component 100 shown in Figures and 2 is readily adaptable to provide electrical components having integrated switch capability. In such an embodiment, the main tank 115 may be used to contain another under-oil or under-liquid electrical component, such as a coil and core assembly 170 (shown in phantom in FIG. 2) of a power distribution transformer.

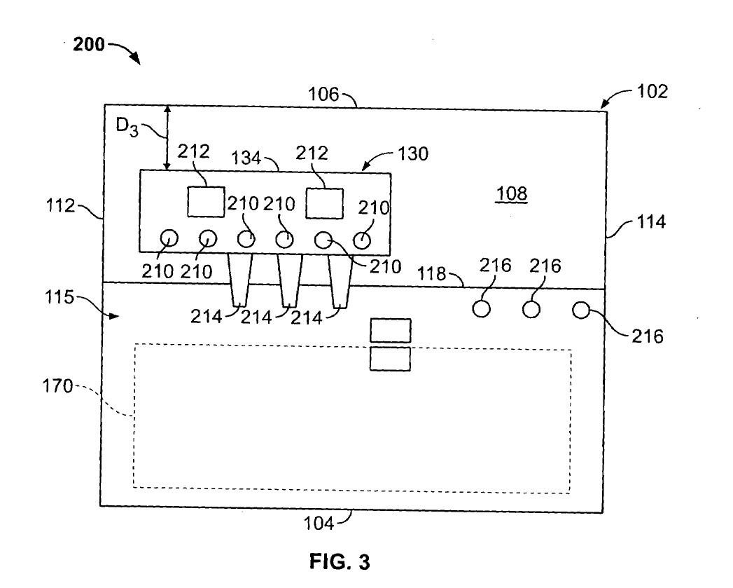

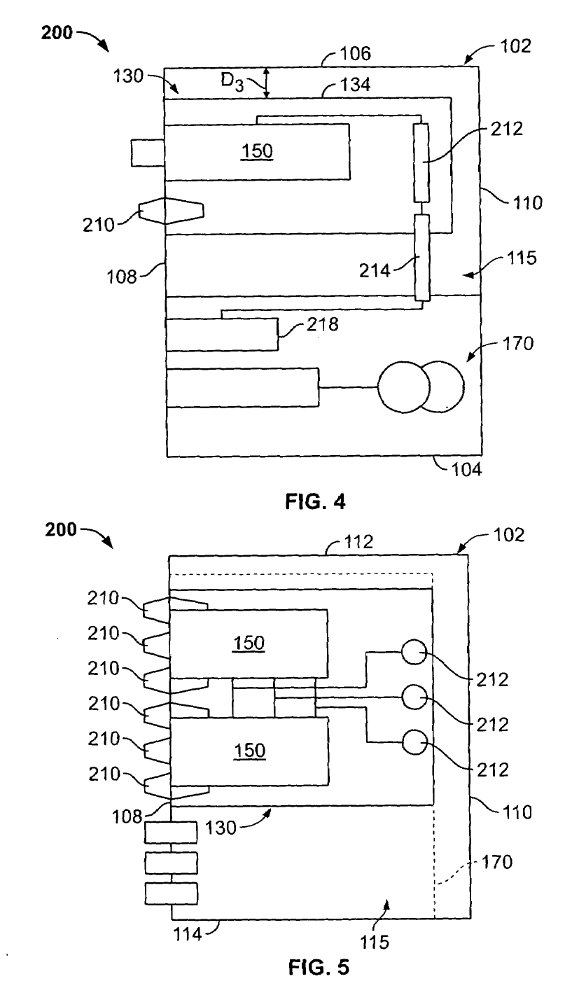

FIGS. 3-5 illustrate schematic layouts of a power distribution transformer utilizing the body 102 as described above, and like reference characters of FIGS. 1 and 2 are indicated with like reference numbers in FIGS. 3-5. FIG. 3 is a front schematic view of the transformer 200. FIG. 4 is a side schematic view of the transformer 200, and FIG. 5 is a top schematic view of the transformer 200.

In the embodiment of FIGS. 3-5, that main tank 115 functions as a transformer tank, with integral switching devices 150 included in the switch tank 130 within the transformer tank. In such an embodiment, an existing transformer tank 115 may be modified to include the switch tank 130 in a single package, and electrical connections can be made in a sheet metal cable cubicle that is part of the transformer itself. A tamperproof connection space is therefore provided, eliminating the need for a larger, more costly kiosk or a room within a building to house a power distribution transformer and ring main switch as has conventionally been done. Additionally, because of the switch tank 130 being located within the main transformer tank 115, the total footprint for the tank-in-a-tank design of the transformer 200 is smaller than the combined transformer and ring switch combination which has been conventionally been used in Europe.

In an exemplary embodiment, the top wall or cover of the switch tank 30 may be spaced a distance D₃ of, for example, about 75 mm to about 100 mm below the top wall or cover 106 of the main transformer tank 115. The sides and back of the switch tank 130 may be about the same distance from corresponding walls of the main tank 115, although other spacing values may alternatively be used as appropriate. Also in an exemplary embodiment, the switch tank 130 is dimensioned to have a clearance above the dielectric fluid 118 in the switch tank 130 of about 75 mm to about 100 mm to create an adequate headspace in the switch tank. Again, it is recognized that greater or lesser amounts of headspace may be provided in other embodiments.

As shown in FIG. 5, two loadbreak switch devices 150 are provided in the switch tank 130 for line connections via high voltage bushings 210 extending through the front panel or front wall 108. Additionally, protective elements such as current limiting fuses 212 may be provided in a single small switch tank 130 mounted near the top cover 106 of the main transformer tank 115. In accordance with known loadbreak switches, each of the loadbreak switches 150 is operable in an on, off and earth ground position. Optional switch position indicating view windows 212 and the like may be placed in the switch tank area on the common front plate 108 so that the operating position of the switch devices 150 may be visually confirmed from the exterior of the body 102. Viewing ports or other devices may also be provided to demonstrate that the fluid in either tank is present and is at the proper depth.

High voltage cables connect the switch devices 150 in the switch tank 130 to the bushings 210, and also interconnect the switch devices 150. High voltage cables are also provided to connect the switch devices 150 to the current limiting fuses 212 that may be mounted, for example, in the back of the switch tank 130. The current limiting fuses 212 may then be connected to high voltage bushings 214 that carry power out of the switch tank 130 into the dielectric fluid 118 in the transformer tank 115. A transformer core and coil assembly 170 is immersed in the dielectric fluid 118 in the transformer tank 115.

Low voltage bushings 216, and a protective element 218 such as a primary breaker or Bayonet fuse may also be provided in the main tank 115 to protect the core and coil assembly 170. The transformer tank size is determined by the core coil size, appropriate clearances for the electrical elements in the transformer tank 115, and the need to mount the low voltage bushings 216 and the switching devices in the switch tank 130.

The tank-in-a-tank construction of the transformer 200 prevents large pressure impulses resulting from a high-current failure within the switching tank 130 from rupturing the main transformer tank 115 as substantially described above. Pressure relief devices to vent the pressure inside the switch tank 130 and/or the main tank 115 may also be provided to reduce the likelihood of rupture of either tank should the current significantly exceed, for example, 16 kA or the should the duration of the current flow exceed 0.5 seconds.

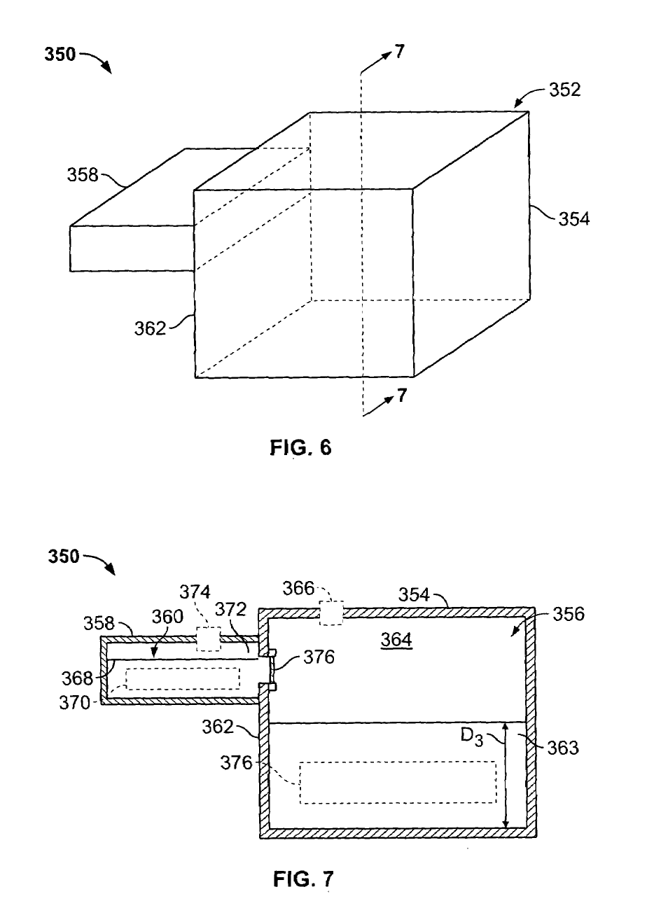

FIGS. 6 and 7 illustrates another embodiment of an electrical component 350 providing similar benefits to the above-described embodiments in relation to FIGS. 1-5, but having an alternative tank structure.

The component 350 includes a body 352 that, like the foregoing embodiments may be fabricated from metal plates. The body defines a primary tank 354 having a first generally hollow interior volume or space 356 and a secondary or switch tank 358 defining a generally hollow interior volume or space 360 that is separate and distinct from the interior volume 356 of the main tank 354 in normal use. The main tank 354 and the switch tank 358 may share a common wall 362 in the tank construction. Unlike the prior embodiments, the switch tank 358 is located exterior to the main tank 354.

The interior volume 356 of the main tank 354 may be sealed and filled with a dielectric fluid 363 to a depth D3, with an optional inert gas blanket being formed in a headspace 364 above the fluid 363. A pressure relief device 366 may be provided in the main tank as described above. Likewise, the switch tank 358 is filled with a dielectric fluid 368 to a depth sufficient to immerse a high voltage switching device 370 (shown in phantom in FIG. 7) therein. An optional inert gas blanket may also be formed in a headspace 372 of the switch tank 358, and a pressure relief device 374 may be provided in the switch tank. Any of the aforementioned dielectric fluids and gases may be utilized as the fluids 363 and 368 in the component 350.

Like the foregoing embodiments, the switch tank 358 may include a bursting plate or section 376 of a smaller thickness than other portions of the tank, or alternatively the bursting plate or section 376 may be fastened to the tank with fasteners that are designed to shear when loaded by pressure in the switch tank 358. In the illustrated embodiment, the busting plate or section 376 is part of the common wall 362 extending between the tanks 354 and 358 such that when the bursting plate gives way, fluid communication is established between the smaller switch tank 358 and the larger main tank 354 to relieve pressure in the switch tank 358 to prevent its rupture, while containing the contents of the switch tank 358 in a location confined to the main tank 354. The component 350 is therefore fault tolerant in a substantially similar manner as the foregoing embodiments.

Like the previous embodiments, the component 350 is readily adaptable from a stand-alone switching unit to another component having integral switching capability, such as a transformer, by including a core and coil assembly 378 (shown in phantom in FIG. 7) and other protective components, breakers, etc. as described above. The switch tank 358 may also include protective components such as fuses and the like as described above. Bushing connectors and high voltage cables may be utilized to connect the component to line and load circuits, and to interconnect the operative components in the tanks 354 and 358.

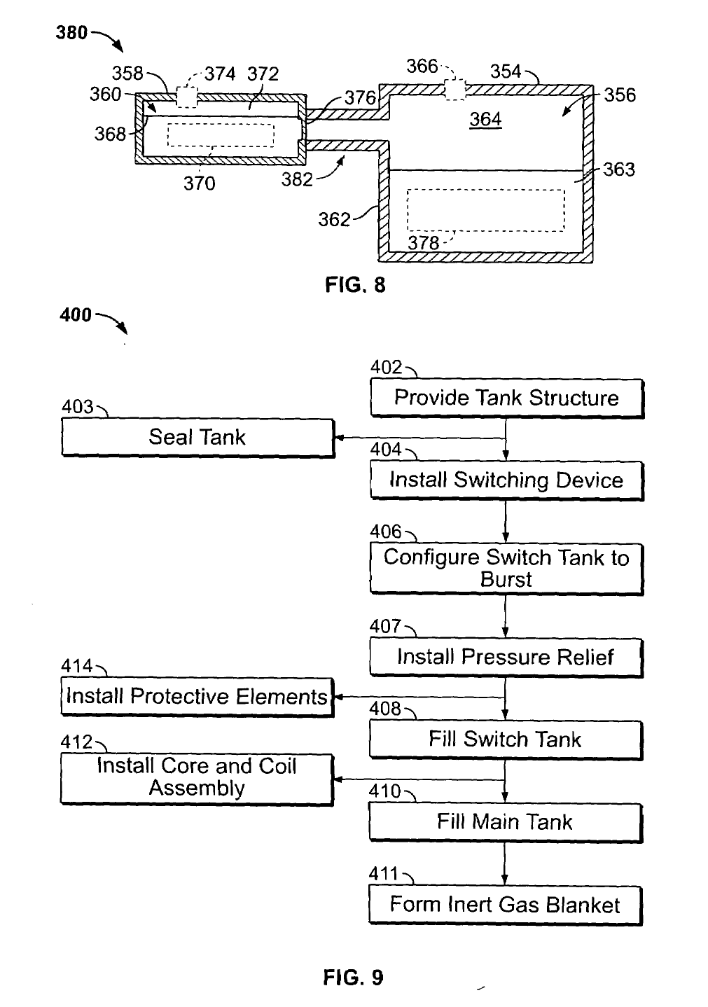

FIG. 8 illustrates another embodiment of an electrical component 380 that is similar to the component 350 shown in FIG. 7, and in which like features of the component 350 are indicated with like reference characters in FIG. 8. Unlike the component 350, the switch tank 358 and the main tank 354 are interconnected by a passage or duct 382. Thus, the main tank 354 and the switch tank 358 do not share a common wall in the component 380.

Like the embodiments described above, the main tank 354 and the switch tank are not in fluid communication with one another during normal use and normal operating conditions of the component 380. The bursting plate 376, however, opens to the duct 382 and establishes fluid communication between the tanks 354 and 358 via the duct 382 when fault conditions occur and pressure builds up to a predetermined amount in the switch tank 358. When the bursting plate gives way, fluid communication is established between the smaller switch tank 358 and the larger main tank 354 to relieve pressure in the switch tank 358 to prevent its rupture, while containing the contents of the switch tank 358 in a location confined to the main tank 354. The component 350 is therefore fault tolerant in substantially the same manner as the foregoing embodiments.

III. Inventive Methods

Having now described the structure and function of exemplary embodiments of the invention, an exemplary method flowchart for a method 400 of assembling a fault tolerant high voltage electric component is also illustrated in relation to FIG. 9.

As shown in FIG. 6, the method includes providing 402 a body defining a tank structure having a main tank and a switch tank as described above, wherein the main tank is larger than the switch tank. If not provided in the step 402, sealing 403 of the main and switch tanks may be accomplished in a known manner. Installing 404 a high voltage switching device in the switch tank may be performed, and either before or after installation of the switching device, the switch tank may be configured 406 to burst open in response to a specified pressure build up in the switch tank, wherein when the switch tank bursts open, pressure in the switch tank is released to the larger main tank. Additionally, installing 407 a pressure relief device in one or both of the main tank and the switch tank may be desirable.

Once the switching element is installed 404, filling 408 the switch tank with a dielectric fluid, examples of which are set forth above, in an amount sufficient to immerse, cover, and adequately insulate the high voltage switching device may be performed. The filling 408 of the switch tank should be accomplished while considering that a certain amount of headspace in the switch tank is desirable. Filling 410 the main tank with a dielectric fluid may also be accomplished, also keeping in mind that a certain amount of headspace in the main tank is desirable. Forming 411 inert gas blankets in the switch tank and the main tank may be accomplished by subjecting the tank to a vacuum, removing any air present in the tank and then adding the inert gas or gases to form the blankets. If desired, a tank with a bleed valve may be added to the inside of the tank to provide a constant supply of the inert gas.

Additional components may also be installed in the main tank prior to filling it with dielectric fluid. For example, installing 412 a transformer coil and core assembly in the main tank, may be desirable. Installing 414 one or more protective elements, such as fuses in the switch tank, may also be performed. Installation 414 of a protective element may also include installation of elements such a fuse, breaker or limiter, in the main tank. Connecting bushings and cables may also be provided to interconnect the operative components in the manner described above.

Using the above-described methodology, stand-alone switching units and transformers having integrated switch devices may be provided with relative ease. SF₆ gas need not be employed in the construction of the units and transformers. The units and transformers provided by the method 300 are fault tolerant and may capably meet international standards and regulations. In particular, because of the double tank construction of the switching units and transformers, the units or transformers may capably withstand fault currents of 16 kA for a duration of 0.5 1.0 second or longer without rupturing of the main tank and release of gas and fluid into the external environment.

IV. Conclusion

Various exemplary embodiments have now been described that are believed to amply demonstrate the construction, operation, methodology and substantial benefit of the invention. The embodiments described include at least the following.

One embodiment of a high voltage electrical component is disclosed. The component comprises a body comprising a primary tank defining a first interior volume and a secondary tank integral to the first tank and defining a second interior volume. The second volume is less than the first volume. A switching device is contained in the secondary tank, and the first and second tank are not in fluid communication with one another during normal operating conditions of the switching device.

Optionally, the switching device in the secondary tank may be immersed in a liquid dielectric fluid. The liquid dielectric fluid in the switch tank may be oil based, and may be formulated from seed oil. The secondary tank may be configured to burst upon a predetermined pressure buildup in the secondary tank. The primary tank and the secondary tank may share a common wall. The primary tank may also contain a depth of a dielectric fluid, and the dielectric fluid in the main tank may be oil based, and may be formulated from seed oil. An inert blanket may be provided in one of the primary tank and the secondary tank. A pressure relief device may be provided in one of the primary tank and the secondary tank. The primary tank may comprise at least one viewing window to facilitate visual confirmation of a position of the switching device. The component may be a power distribution transformer, and the primary tank may contain a core and coil assembly immersed in a dielectric fluid.

Another embodiment of a high voltage electrical component is also disclosed. The component includes a body comprising a main tank and a switch tank integral to the main tank. The main tank defines a first internal volume, with the first internal volume containing a first amount of dielectric fluid and a first headspace. The second tank defines a second internal volume distinct from the first internal volume and the second internal volume is less than the first internal volume. A high voltage switching device is enclosed in the switch tank in the second internal volume.

Optionally, The main tank and the switch tank may share a common wall, and a high voltage transformer core and coil assembly may be immersed in the first amount of dielectric fluid. The dielectric fluid may be formulated from seed oil, or another oil-based fluid. The switching device may be immersed in a second amount of dielectric fluid in the switch tank. The dielectric fluid in the switch tank may be formulated from seed oil or an oil-based fluid. An inert gas blanket may be provided in the headspace of the main tank, and the switch tank may be configured to burst upon a predetermined pressure buildup in the switch tank, thereby releasing pressure from the switch tank into the main tank. A pressure relief device may be provided in one of the primary tank and the secondary tank.

Another embodiment of a high voltage electrical component is disclosed herein. The component includes a metal body comprising a main tank and a switch tank integrally attached to the main tank, and a high voltage switching device enclosed in the switch tank. The main tank defines a first internal volume, and the first internal volume may be partly filled with a first amount of dielectric fluid, with a remainder of the first internal volume forming a first headspace in the main tank. The second tank defines a second internal volume, with the second internal volume being less than the first internal volume. The second internal volume is partly filled with a second amount of dielectric fluid and a remainder of the second internal volume forming a second headspace in the switch tank. A bursting element is connected between the switch tank and the main tank, and the bursting element is responsive to pressure conditions in the switch tank generated in a fault condition to release excessive pressure into the main tank without external rupture of the switch tank

Optionally, the component may comprise a high voltage transformer core and coil assembly immersed in the first amount of dielectric fluid. The first amount of dielectric fluid may be formulated from seed oil or may comprise another oil based fluid. The body may be fabricated from metal plates, and an inert gas blanket may provided in one of the first headspace and the second headspace. A pressure relief device may be provided in one of the primary tank and the secondary tank. The main tank and the switch tank may share a common wall. A protective element may be provided, with the protective element being contained in the switch tank and connected to the switching device. The switching device may be operable between open, closed and earth ground positions.

A method of assembling a fault tolerant high voltage electric component is also disclosed. The method includes providing a body defining a main tank and a switch tank contained within the main tank, wherein the main tank is larger than the switch tank; installing a high voltage switching device in the switch tank; and configuring the switch tank to communicate with main tank only in response to a specified pressure build up in the switch tank, thereby releasing pressure in the switch tank to the main tank. The method also includes filling the switch tank with a dielectric fluid in an amount sufficient to cover the high voltage switching device.

Optionally, the method may further include sealing at least one of the first and second tanks, filling the main tank with a dielectric fluid, installing a pressure relief device in one of the main tank and the switch tank. installing a transformer coil and core assembly in the main tank. installing a protective element in the switch tank, and installing a protective element in the main tank.

An embodiment of a high voltage electric component is also disclosed. The component includes a first means for containing a dielectric fluid and a second means for containing a dielectric fluid, with the second means being smaller than the first means. Means for switching a high voltage electrical connection are provided in the second means for containing fluid, wherein the second means for containing dielectric fluid is not in fluid communication with the first means for containing fluid under normal operation. The second means establishes fluid communication with the first means when a fault current of 16 kA occurs for at least 0.5 second; and the first means withstands the fault current without rupturing.

Optionally, means for bursting the second means for containing a dielectric fluid to place the first and second means in fluid communication with one another when the fault condition occurs. Means for relieving pressure in the first means for containing a dielectric fluid may also be provided. Transformer means may be provided in the first means for containing a dielectric fluid.

While the invention has been described in terms of various specific embodiments, those skilled in the art will recognize that the invention can be practiced with modification within the spirit and scope of the claims.

What is claimed is:

1. A high voltage electrical component comprising:
a body comprising a primary tank defining a first interior volume and a secondary tank integral to the first tank and defining a second interior volume, wherein the second volume is less than the first volume; and
a switching device contained in the secondary tank;
wherein the first and second tank are not in fluid communication with one another during normal operating conditions of the switching device.

2. The component of claim 1, wherein the component is a power distribution transformer, and the primary tank contains a core and coil assembly immersed in a dielectric fluid.

3. The component of claim 1, wherein the switching device in the secondary tank is immersed in a liquid dielectric fluid.

4. The component of claim 3, wherein the liquid dielectric fluid is oil based.

5. The component of claim 4, wherein the liquid dielectric fluid is formulated from seed oil.

6. The component of claim 1, wherein the primary tank contains a depth of a dielectric fluid.

7. The component of claim 6, wherein the dielectric fluid is oil based.

8. The component of claim 7, wherein the dielectric fluid is a liquid dielectric fluid formulated from seed oil.

9. The component of claim 1, further comprising an inert blanket provided in one of the primary tank and the secondary tank.

10. The component of claim 1, wherein the secondary tank is configured to burst upon a predetermined pressure buildup in the secondary tank.

11. The component of claim 1, further comprising a pressure relief device in one of the primary tank and the secondary tank.

12. The component of claim 1, wherein the primary tank and the secondary tank share a common wall.

13. The component of claim 1, wherein the primary tank comprises at least one viewing window to facilitate visual confirmation of a position of the switching device.

14. A high voltage electrical component comprising:
a body comprising a main tank and a switch tank integral to the main tank;
the main tank defining a first internal volume, the first internal volume containing a first amount of dielectric fluid and a first headspace;
wherein the second tank defines a second internal volume distinct from the first internal volume, the second internal volume being less than the first internal volume; and
a high voltage switching device enclosed in the switch tank in the second internal volume.

15. The component of claim 14, further comprising a high voltage transformer core and coil assembly immersed in the first amount of dielectric fluid.

16. The component of claim 15, wherein the dielectric fluid is formulated from seed oil.

17. The component of claim 15, wherein the first amount of dielectric fluid comprises an oil-based fluid.

18. The component of claim 14, wherein the switching device is immersed in a second amount of dielectric fluid in the switch tank.

19. The component of claim 18, wherein the dielectric fluid is formulated from seed oil.

20. The component of claim 18, wherein the second amount of dielectric fluid comprises an oil-based fluid.

21. The component of claim 14, further comprising an inert gas blanket in the headspace of the main tank.

22. The component of claim 14, wherein the switch tank is configured to burst upon a predetermined pressure buildup in the switch tank, thereby releasing pressure from the switch tank into the main tank.

23. The component of claim 14, further comprising a pressure relief device in one of the primary tank and the secondary tank.

24. The component of claim 14, wherein the main tank and the switch tank share a common wall.

25. A high voltage electrical component comprising:
a metal body comprising a main tank and a switch tank integrally attached to the main tank; and
a high voltage switching device enclosed in the switch tank;
wherein the main tank defines a first internal volume, the first internal volume being partly filled with a first amount of dielectric fluid and a remainder of the first internal volume forming a first headspace in the main tank;
the second tank defining a second internal volume, the second internal volume being less than the first internal volume, the second internal volume being partly filled with a second amount of dielectric fluid and a remainder of the second internal volume forming a second headspace in the switch tank; and
a bursting element connected between the switch tank and the main tank, the bursting element responsive to pressure conditions in the switch tank generated in a fault condition to release excessive pressure into the main tank without external rupture of the switch tank.

26. The component of claim 25, wherein the component comprises a high voltage transformer core and coil assembly immersed in the first amount of dielectric fluid.

27. The component of claim 25, wherein the first amount of dielectric fluid is formulated from seed oil.

28. The component of claim 25, wherein at least one of the first the first and second dielectric fluids comprises an oil based fluid.

29. The component of claim 25, wherein the body is fabricated from metal plates.

30. The component of claim 25, wherein an inert gas blanket is provided in one of the first headspace and the second headspace.

31. The component of claim 25, further comprising a pressure relief device provided in one of the primary tank and the secondary tank.

32. The component of claim 25, wherein the main tank and the switch tank share a common wall.

33. The component of claim 25, further comprising a protective element, the protective element being contained in the switch tank and connected to the switching device.

34. The component of claim 25, wherein the switching device is operable between open, closed and earth ground positions.

35. A method of assembling a fault tolerant high voltage electric component, comprising:
providing a body defining a main tank and a switch tank, wherein the main tank is larger than the switch tank;
installing a high voltage switching device in the switch tank;
configuring the switch tank to communicate with main tank only in response to a specified pressure build up in the switch tank, thereby releasing pressure in the switch tank to the main tank; and
filling the switch tank with a dielectric fluid in an amount sufficient to cover the high voltage switching device.

36. The method of claim 35, further comprising sealing at least one of the first and second tanks.

37. The method of claim 35, further comprising filling the main tank with a dielectric fluid.

38. The method of claim 35, further comprising installing a pressure relief device in one of the main tank and the switch tank.

39. The method of claim 35, further comprising installing a transformer coil and core assembly in the main tank.

40. The method of claim 35, further comprising installing a protective element in the switch tank.

41. The method of claim 35, further comprising installing a protective element in the main tank.

42. A high voltage electric component comprising:
a first means for containing a dielectric fluid;
a second means for containing a dielectric fluid, the second means being smaller than the first means,
means for switching a high voltage electrical connection in the second means for containing fluid, wherein the second means for containing dielectric fluid is not in fluid communication with the first means for containing fluid under normal operation;
wherein the second means establishes fluid communication with the first means when a fault current of 16 kA occurs for at least 0.5 second; and
wherein the first means withstands the fault current without rupturing.

43. The component of claim 42, further comprising means for bursting the second means for containing a dielectric fluid, thereby placing the first and second means in fluid communication with one another.

44. The component of claim 42, further comprising means for relieving pressure in the first means for containing a dielectric fluid.

45. The component of claim 42, further comprising transformer means in the first means for containing a dielectric fluid.

46. The component of claim 1, wherein the second tank is interior to and surrounded by the first tank.

47. The component of claim 14, wherein the switch tank occupies a portion of the first headspace.

48. The component of claim 25 wherein the switch tank is positioned in the first headspace.
